(19) United States
(12) Patent Application Publication
(10) Pub. No.: US 2017/0210241 A1
(43) Pub. Date: Jul. 27, 2017

(54) BATTERY MODULE WITH HIGH-PRECISION DIGITAL DISPLAY OF BATTERY CAPACITY AND UNMANNED AERIAL VEHICLE

(71) Applicant: EKEN ELECTRONICS LIMITED, Hong Kong (HK)

(72) Inventor: Frank Li, Hong Kong (HK)

(21) Appl. No.: 15/003,829

(22) Filed: Jan. 22, 2016

(51) Int. Cl. B60L 11/18; B64C 39/02; B64D 43/00; H02J 7/00

(52) U.S. Cl. CPC B60L 11/1861; H02J 7/0047; B64C 39/024; B64D 43/00; H02J 2007/005; B64C 2201/024; B64C 2201/141

(57) ABSTRACT

A battery module with a high-precision digital display of a battery capacity includes: a battery capacity detection unit, a main control unit, a digital display unit, and a triggering unit, where the battery capacity detection unit is configured to detect capacity information of the battery module after the triggering unit is triggered; the main control unit is electrically connected to the battery capacity detection unit, and is configured to receive the capacity information of the battery module, and generate a display signal according to the capacity information of the battery module; and the digital display unit is electrically connected to the main control unit, and is configured to display a remaining capacity of the battery module under the control of the display signal. With the battery module, a user can independently, quickly, intuitively, and highly precisely observe a current battery capacity in real time.

### TECHNICAL FIELD

The present invention relates to a battery, and in particular, to a battery module that enables a user to independently, quickly, intuitively, and highly precisely observe a current battery capacity in real time, and an unmanned aerial vehicle (UAV) using the battery module.

### BACKGROUND

To distinguish a battery level of a battery module, a battery level indicating lamp is provided on the battery module. However, a battery level state is only roughly displayed by using multiple indicating lamps or an indicating lamp of multiple colors. Moreover, in a device that requires a high-precision display of a battery level, such as a UAV, the UAV in flight may fall due to an excessively low battery level, causing that the UAV is damaged or destroyed.

### SUMMARY

To solve the foregoing problem, one of the objectives of the present invention is to provide a battery module with a high-precision display of a battery capacity that enables a user to independently, quickly, intuitively, and highly precisely observe a current battery capacity in real time, and another objective of the present invention is to provide a UAV using the battery module.

The present invention is implemented by using the following technical measures: a battery module with a high-precision digital display of a battery capacity, including: a battery capacity detection unit, a main control unit, a digital display unit, and a triggering unit, where the battery capacity detection unit is configured to detect capacity information of the battery module after the triggering unit is triggered; the main control unit is electrically connected to the battery capacity detection unit, and is configured to receive the capacity information of the battery module, and generate a display signal according to the capacity information of the battery module; and the digital display unit is electrically connected to the main control unit, and is configured to display a remaining capacity of the battery module under the control of the display signal.

As a preferable manner, a wireless transmission unit is further included, where the wireless transmission unit is electrically connected to the main control unit, and is configured to receive a control command of a control terminal and wirelessly transmit the capacity information of the battery module to the control terminal.

As a preferable manner, the capacity information includes any one or a combination of a battery voltage, a battery working current, and a battery level.

As a preferable manner, the digital display unit is a liquid crystal display (LCD) screen or a light emitting diode (LED) display screen.

As a preferable manner, the battery module includes a housing; a lower opening of the housing is provided with a lower cover; an upper opening of the housing is provided with an upper cover; an electrochemical cell provided in the housing abuts onto the upper cover and the lower cover; a printed circuit board assembly (PCBA) is fastened to an upper part of the upper cover through a support; the PCBA is provided with a digital display screen; the upper part of the upper cover is further provided with a surface housing; the surface housing and the upper cover are fastened, and enable the PCBA and the support to be accommodated between the surface housing and the upper cover; and the surface housing is provided with a lens capable of transparently displaying the digital display screen.

The present invention further discloses a UAV equipped with the foregoing battery module, including: a UAV body, where the UAV body is provided with the battery module with a high-precision digital display of a battery capacity that supplies power to the UAV; and the control terminal, where the main control unit sends the capacity information of the battery module to the control terminal through a communication module of the UAV body, and the capacity information of the battery module is displayed on a display screen of the control terminal.

As a preferable manner, the UAV body further includes: a positioning and navigating module, configured to determine a current coordinate position of the UAV and obtain, according to the current coordinate position, return route information; and
a control module, configured to obtain a battery level value for a safe return according to the capacity information of the battery module and the return route information, and control the UAV to execute a return task when the battery module has the battery level value for a safe return.

As a preferable manner, a position of the center of gravity of the UAV is provided with battery accommodation space with an upward opening, and the battery module with a high-precision digital display of a battery capacity is vertically inserted into the battery accommodation space from the above.

As a preferable manner, the battery module with a high-precision digital display of a battery capacity is provided as a foolproof structure.

As a preferable manner, the positioning and navigating module is a global navigation satellite system (GNSS) navigating module.

In the present invention, the battery capacity detection unit, the main control unit, the digital display unit, and the triggering unit are provided in the battery. Therefore, the battery module may be enabled by the triggering unit to work independently when in a state of being separated from an electrical device, can clearly display a state of a battery capacity by using the digital display unit, so as to intuitively and quickly select a battery with a relatively high capacity in the field for use, and can accurately predict the usage time of the battery by using the digital display unit, so as to avoid a damage of an electric product such as a UAV caused by a low battery level.

### BRIEF DESCRIPTION OF THE DRAWINGS

FIG. 1 is a structural block diagram of a battery according to an embodiment of the present invention;

FIG. 2 is a schematic structural diagram of a battery according to an embodiment of the present invention;

FIG. 3 is a schematic exploded structural diagram of a battery according to an embodiment of the present invention;

FIG. 4 is a schematic exploded structural side view of a UAV according to an embodiment of the present invention; and

FIG. 5 is a schematic structural top view of a UAV according to an embodiment of the present invention.

### DETAILED DESCRIPTION

The present invention is further described in detail below with reference to embodiments and accompanying drawings.

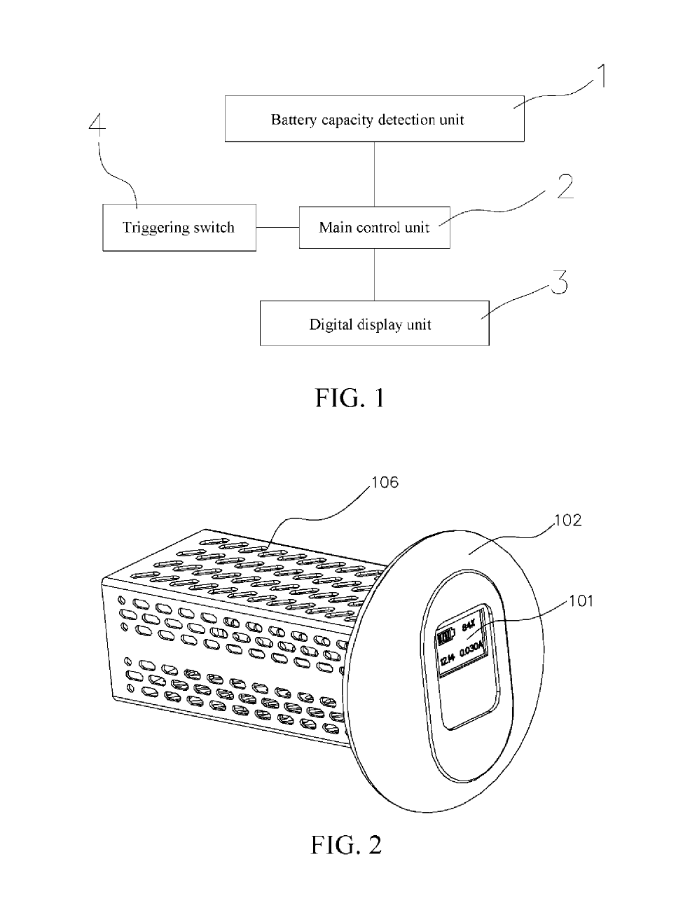

Referring to FIG. 1, a battery module with a high-precision digital display of a battery capacity includes a battery capacity detection unit 1, a main control unit 2, a digital display unit 3, and a triggering unit 4, where the battery capacity detection unit 1 is configured to detect capacity information of the battery module after the triggering unit 4 is triggered; the main control unit 2 is electrically connected to the battery capacity detection unit 1, and is configured to receive the capacity information of the battery module, and generate a display signal according to the capacity information of the battery module; and the digital display unit 3 is electrically connected to the main control unit 2, and is configured to display a remaining capacity of the battery module under the control of the display signal.

In the present battery module, the battery capacity detection unit 1, the main control unit 2, the digital display unit 3, and the triggering unit 4 are provided in the battery module. Therefore, the battery module may be enabled by the triggering unit 4 to start a battery capacity detecting function when in a state of being separated from an electrical device, can clearly display a state of a battery capacity in a digital form by using the digital display unit 3, so as to intuitively and quickly select a battery with a relatively high capacity in the field for use, and can accurately predict the usage time of the battery by using the digital display unit 3, so as to avoid a damage of an electric product such as a UAV caused by a low battery level.

On the basis of the preceding technical solution, specifically, the battery module with a high-precision digital display of a battery capacity may further include a wireless transmission unit, where the wireless transmission unit is electrically connected to the main control unit, and is configured to receive a control command of a control terminal and wirelessly transmit the capacity information of the battery module to the control terminal. Therefore, detections on multiple batteries may be enabled at a time by using the control terminal such as a mobile phone; batteries of different capacity levels may be first distinguished by using colors displayed by the digital display unit (for example, a high capacity is displayed as green, a middle capacity is displayed as yellow, and a low capacity is displayed as red); and batteries that need to be used or charged are further screened by using digits displayed by the digital display unit.

On the basis of the preceding technical solution, specifically, in the battery module with a high-precision digital display of a battery capacity, the capacity information includes any one or a combination of a battery voltage, a battery working current, and a battery level.

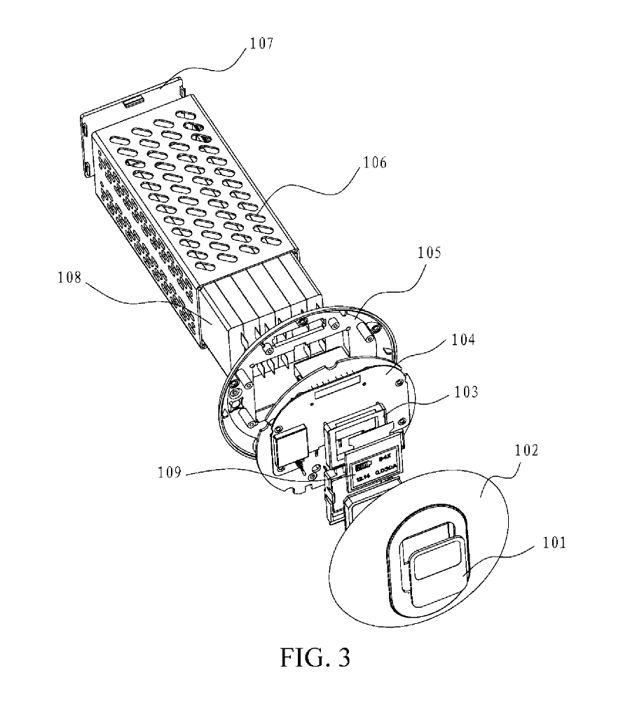

Referring to FIG. 2 and FIG. 3, an embodiment of a battery module with a high-precision digital display of a battery capacity includes an aluminum alloy housing 106; the aluminum alloy housing 106 is provided with apertures for heat dissipation; a lower opening of the aluminum alloy housing 106 is provided with a lower cover 107; an upper opening of the aluminum alloy housing 106 is provided with an upper cover 105; a polymer electrochemical cell 108 provided in the aluminum alloy housing 106 abuts onto the upper cover 107 and the lower cover 105; a printed circuit board assembly (PCBA) 104 is fastened to an upper part of the upper cover 105 through a support 103; the PCBA 104 is provided with a battery capacity detection unit, a main control unit, and a digital display screen 109, and is connected to a triggering unit; the triggering unit may be electrically connected to the main control unit and is provided in the aluminum alloy housing 106, may also be a wireless module provided on the PCBA 104, or both; in this embodiment, the digital display screen is an LCD screen, and in other embodiments, a digital display screen may also be an LED display screen or other display screens; an upper part of the upper cover 105 is further provided with a surface housing 102; the surface housing 102 and the upper cover 105 are fastened, and enable the PCBA 104 and the support 103 to be accommodated between the surface housing 102 and the upper cover 105; the surface housing is provided with a lens 101 capable of transparently displaying the digital display screen 109; and referring to FIG. 2, the LCD screen may highly precisely display battery level information of a battery voltage and a battery working current by using digits, so as to intuitively provide a basis for selecting a battery.

On the basis of the preceding technical solution, specifically, in the battery module with a high-precision digital display of a battery capacity according to this embodiment, referring to FIG. 2, and FIG. 3, a data connector protruded from the upper cover 105 and located at a side edge of the housing and a power supply connector protruded from the upper cover and located at a side edge of the housing are extended from an lower surface of the PCBA 104, so as to help the usage after a battery is inserted, and prevent, by using two different connectors, a short circuit caused by reverse insertion and removal of a battery.

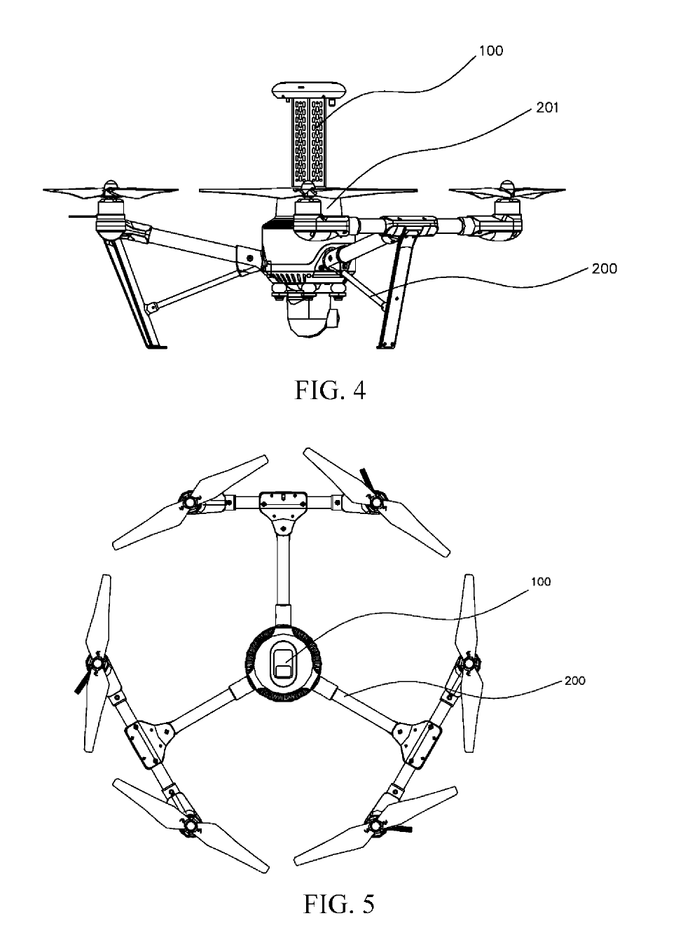

Referring to FIG. 4 to FIG. 5, a UAV equipped with the foregoing battery includes: a UAV body 200, where the UAV body 200 is provided with a battery module 100 with a high-precision digital display of a battery capacity that supplies power to the UAV; and a control terminal (generally, it is a remote controller, and may also be a smart phone, a tablet computer, and the like that is installed with remote control APP software), where the main control unit sends the capacity information of the battery module to the control terminal through a communication module of the UAV body, and the capacity information of the battery module is displayed on a display screen of the control terminal. Therefore, a battery level is detected, and a detection result is sent to the control terminal. Thus, when operating the control terminal to control the UAV to fly, a user can observe a current remaining capacity of the UAV in real time.

On the basis of the preceding technical solution, specifically, in the UAV of the present embodiment, the UAV may further include a positioning and navigating module, configured to determine a current coordinate position of the UAV and obtain, according to the current coordinate position, return route information; and
a control module, configured to obtain a battery level value for a safe return according to the capacity information of the battery module and the return route information, and control the UAV to execute a return task when the battery module has the battery level value for a safe return. In this embodiment, the control module obtains the battery level value for a safe return by monitoring remaining battery level percentage information in real time, and calculating a battery level used for a return according to a return route. The control module calculates the battery level required for a return according to the return route information in real time and monitors the remaining battery level percentage information in real time, and controls the UAV to return when the battery module has the battery level value for a safe return. Therefore, it is ensured that the UAV returns and is timely charged when the battery is going to run out, so as to further guarantee a safe flight of the UAV during a process that the user controls the UAV to fly. In this embodiment, the positioning and navigating module is a GNSS navigating module.

Referring to FIG. 4 to FIG. 5, on the basis of the preceding technical solution, specifically, in the UAV of this embodiment, a position of the center of gravity of the UAV body 200 is provided with battery accommodation space 201 with an upward opening, and the battery module with a high-precision digital display of a battery capacity 100 is vertically inserted into the battery accommodation space 201 from the above. The battery 100 is inserted into the battery accommodation space 201 at the position of the center of gravity of the UAV body 200, and therefore, the battery is maintained at a position of the center of the UAV body, so that the balance can be greatly controlled in a flying process. The battery is directly inserted from the above, and therefore, the removal and placing of the battery is very convenient. The battery 100 is asymmetrically arranged, and therefore, a short circuit caused by reverse insertion and removal of the battery may be avoided.

The battery module with a high-precision digital display of a battery capacity and the UAV of the present invention are described above, and the above descriptions are used to help the comprehension of the present invention. However, implementation manners of the present invention are not limited by the foregoing embodiments. Any variations, modifications, replacements, combinations, and simplifications made without departing from the principles of the present invention shall be equivalent replacement manners, and shall be included within the protection scope of the present invention.

What is claimed is:

1. A battery module with a high-precision digital display of a battery capacity, comprising: a battery capacity detection unit, a main control unit, a digital display unit, and a triggering unit, wherein the battery capacity detection unit is configured to detect capacity information of the battery module after the triggering unit is triggered; the main control unit is electrically connected to the battery capacity detection unit, and is configured to receive the capacity information of the battery module, and generate a display signal according to the capacity information of the battery module; and the digital display unit is electrically connected to the main control unit, and is configured to display a remaining capacity of the battery module under the control of the display signal.

2. The battery module with a high-precision digital display of a battery capacity according to claim 1, further comprising: a wireless transmission unit, wherein the wireless transmission unit is electrically connected to the main control unit, and is configured to receive a control command of a control terminal and wirelessly transmit the capacity information of the battery module to the control terminal.

3. The battery module with a high-precision digital display of a battery capacity according to claim 1, wherein the capacity information comprises any one or a combination of a battery voltage, a battery working current, and a battery level.

4. The battery module with a high-precision digital display of a battery capacity according to claim 1, wherein the digital display unit is a liquid crystal display (LCD) screen or a light emitting diode (LED) display screen.

5. The battery module with a high-precision digital display of a battery capacity according to claim 1, wherein the battery module comprises a housing; a lower opening of the housing is provided with a lower cover; an upper opening of the housing is provided with an upper cover; an electrochemical cell provided in the housing abuts onto the upper cover and the lower cover; a printed circuit board assembly (PCBA) is fastened to an upper part of the upper cover through a support; the PCBA is provided with a digital display screen; the upper part of the upper cover is further provided with a surface housing; the surface housing and the upper cover are fastened, and enable the PCBA and the support to be accommodated between the surface housing and the upper cover; and the surface housing is provided with a lens capable of transparently displaying the digital display screen.

6. An unmanned aerial vehicle (UAV) equipped with the battery module according to claim 1, comprising: a UAV body, wherein the UAV body is provided with the battery module with a high-precision digital display of a battery capacity that supplies power to the UAV body; and the control terminal, wherein the main control unit sends the capacity information of the battery module to the control terminal through a communication module of the UAV body, and the capacity information of the battery module is displayed on a display screen of the control terminal.

7. The UAV according to claim 6, wherein the UAV body further comprises: a positioning and navigating module, configured to determine a current coordinate position of the UAV and obtain, according to the current coordinate position, return route information; and
a control module, configured to obtain a battery level value for a safe return according to the capacity information of the battery module and the return route information, and control the UAV to execute a return task when the battery module has the battery level value for a safe return.

8. The UAV according to claim 6, wherein the battery module further comprises: a wireless transmission unit, wherein the wireless transmission unit is electrically connected to the main control unit, and is configured to receive a control command of a control terminal and wirelessly transmit the capacity information of the battery module to the control terminal.

9. The UAV according to claim 8, wherein the UAV body further comprises: a positioning and navigating module, configured to determine a current coordinate position of the UAV and obtain, according to the current coordinate position, return route information; and
a control module, configured to obtain a battery level value for a safe return according to the capacity information of the battery module and the return route information, and control the UAV to execute a return task when the battery module has the battery level value for a safe return.

10. The UAV according to claim 6, wherein the capacity information comprises any one or a combination of a battery voltage, a battery working current, and a battery level.

11. The UAV according to claim 10, wherein the UAV body further comprises: a positioning and navigating module, configured to determine a current coordinate position of the UAV and obtain, according to the current coordinate position, return route information; and
a control module, configured to obtain a battery level value for a safe return according to the capacity information of the battery module and the return route information, and control the UAV to execute a return task when the battery module has the battery level value for a safe return.

12. The UAV according to claim 6, wherein the digital display unit is a liquid crystal display (LCD) screen or a light emitting diode (LED) display screen.

13. The UAV according to claim 12, wherein the UAV body further comprises: a positioning and navigating module, configured to determine a current coordinate position of the UAV and obtain, according to the current coordinate position, return route information; and
a control module, configured to obtain a battery level value for a safe return according to the capacity information of the battery module and the return route information, and control the UAV to execute a return task when the battery module has the battery level value for a safe return.

14. The UAV according to claim 6, wherein the battery module comprises a housing; a lower opening of the housing is provided with a lower cover; an upper opening of the housing is provided with an upper cover; an electrochemical cell provided in the housing abuts onto the upper cover and the lower cover; a printed circuit board assembly (PCBA) is fastened to an upper part of the upper cover through a support; the PCBA is provided with a digital display screen; the upper part of the upper cover is further provided with a surface housing; the surface housing and the upper cover are fastened, and enable the PCBA and the support to be accommodated between the surface housing and the upper cover; and the surface housing is provided with a lens capable of transparently displaying the digital display screen.

15. The UAV according to claim 14, wherein the UAV body further comprises: a positioning and navigating module, configured to determine a current coordinate position of the UAV and obtain, according to the current coordinate position, return route information; and
a control module, configured to obtain a battery level value for a safe return according to the capacity information of the battery module and the return route information, and control the UAV to execute a return task when the battery module has the battery level value for a safe return.
